(19) United States
(12) Patent Application Publication
(10) Pub. No.: US 2014/0231403 A1
(43) Pub. Date: Aug. 21, 2014

(54) Stone Surface Heater and Methods of Installation

(71) Applicant: JAHN JEFFERY STOPPERAN, Lakeville, MN (US)

(72) Inventor: JAHN JEFFERY STOPPERAN, Lakeville, MN (US)

(21) Appl. No.: 14/184,497

(22) Filed: Feb. 19, 2014

Related U.S. Application Data
(60) Provisional application No. 61/850,662, filed on Feb. 21, 2013.

(51) Int. Cl. A47B 77/08; H05B 1/02

(52) U.S. Cl. CPC A47B 77/08; H05B 1/0252; H05B 1/02
USPC 219/213; 219/482; 219/546

(57) ABSTRACT

A system for heating a countertop includes a heater comprising a plastic film having a patterned heating element disposed thereon, the patterned heating element defining a resistive path on the plastic film shaped to provide closely-spaced heating traces and shaped to be affixed to an underside of the countertop. The system also includes a control unit electrically connectable to the heating element via a wire, the control unit configured to deliver a direct current signal having a predetermined voltage level to the heating element according to a user selectable power level.

### CROSS-REFERENCE TO RELATED APPLICATIONS

The present application claims priority from U.S. Provisional Patent Application No. 61/850,662, filed on Feb. 21, 2013, and entitled “Heated Stone Countertop Technology”, the disclosure of which is hereby incorporated by reference in its entirety.

### BACKGROUND

Granite, marble, quartz and other stone materials are fabricated into countertops, floors, tables, seats, bar tops, railings, walls, workstations, and other support and decorative structures in homes and businesses. These materials exhibit a negative cold temperature characteristic. Specifically, although the stone itself is at room temperature, the stone surface feels cool or even perhaps cold to the touch. The cold characteristic exhibited by such materials can present a barrier to customers who are seeking to select stone over artificial surfaces that do not have the same surface characteristics. Additionally, workstations made of stone, such as those used by persons sitting at a computer or at a stone-surfaced desk, can create physical ailments and discomfort when the user's arms and hands are in-contact with the stone for long durations. Accordingly, prior solutions have presented systems to heat such countertops to approximately 80-95 degrees Fahrenheit, which are temperatures that enable a user to no longer experience coldness, but instead to perceive the surface as a luxurious and exclusive high-quality material.

Countertop surfaces such as stone countertops, which are commonly 2-3 cm thick, have poor thermal conductivity, which is noticeable when exposed to single-point heat generation. In particular, when the stone is heated in a single location, only the area directly adjacent to the heating element rises in temperature, leaving the temperature associated with the remaining areas of the stone either unaffected or negligibly affected. For example, applying a single-point heat source of approximately 95 degrees Fahrenheit to the lower surface of a 3 cm granite slab at a 70 degrees Fahrenheit initial temperature will result in the upper surface that is directly over the heat source to rise by 20 degrees Fahrenheit in 70-80 minutes. However, the stone surface directly above a location ½″ from the center point of the heat source on the lower surface will rapidly decline in temperature relative to the location directly above the heat source. This sharp gradient decline in temperature is even more pronounced further away from the heated center point. For example, within 1″ of the heating element, the temperature can decline by 10 degrees Fahrenheit. Accordingly, attempts to heat stone surfaces suffer from uneven heating, resulting in hot and cold spots in the countertop.

Traditional countertop heaters create uneven heat at a surface encountered by a user because the heating elements are spaced apart by a substantial distance (e.g., typically about 3 inches or more). Serpentine elements, wires, fluid based heating, and other types of heaters all produce uneven thermal patterns in countertops, such as stone countertops. Additionally, floor heaters and radiant floor heaters often result in hot and cold spots that are less noticeable for floors, but unacceptable for countertops. Additionally, stone countertops are slow to change temperature, which introduces difficulty in measuring and controlling the temperature of the stone. In particular, because of the slow thermal change of the stone, once a heating element in a heating cycle reaches a desired temperature, the thermal mass will continue to rise despite the fact that the heating element has been shut off. The opposite will also occur when cooling the stone. The result of this cycle is that the stone will experience undesirably wide temperature swings.

Additionally, the prior art solutions to heating countertops discussed above are thick and bulky, which largely preclude heating exposed areas such as a countertop overhang. In particular, these bulky heater solutions are hidden from plain sight when installed under a counter, but would be difficult and highly undesirable to install under a countertop overhang where such a heater would be highly visible. The added thickness of these prior art heaters are unattractive and would greatly diminish the appeal of a luxurious countertop. Additionally, because many countertops are customized in shapes and layouts that are specifically designed for individual homes, traditional heating element designs are not economically or physically feasible. Additionally, traditional heating elements are thick and visually undesirable under an overhanging countertop, particularly in homes and businesses where the owner expects the stone to portray luxury.

### SUMMARY

In general terms, this disclosure is directed to a system for heating a countertop that includes a heater comprising a plastic film having a patterned heating element disposed thereon, the patterned heating element defining a resistive path on the plastic film shaped to provide closely-spaced heating traces and shaped to be affixed to an underside of the countertop. The system also includes a control unit electrically connectable to the heating element via a wire, the control unit configured to deliver a direct current signal having a predetermined voltage level to the heating element according to a user selectable power level.

In another aspect, a heating system for a countertop is disclosed. The heating system includes a heater comprising a plastic film having a patterned heating element disposed thereon, the patterned heating element defining a resistive path on the plastic film shaped to provide closely-spaced heating traces, the heater installed on an underside of a countertop. The heating system also includes a control unit electrically connected to the heating element, the control unit configured to deliver a direct current signal having a predetermined voltage level to the heating element according to a user selectable power level, the user-selectable power level defining a duty cycle for delivering the direct current signal to the heating element at the predetermined voltage. The heating system further includes a wire extending from the heater to the control unit.

### BRIEF DESCRIPTION OF THE DRAWINGS

FIG. 1A illustrates a perspective view of an example environment in which an embedded stone heater for a stone surface is used.

FIG. 1B illustrates a perspective view of an example environment in which multiple connected embedded stone heaters for a stone surface is used.

FIG. 2 illustrates a perspective view of the bottom surface of a stone countertop with an embedded heater.

FIG. 3 illustrates a thin, flexible heater that provides heat to the edge of a countertop.

FIG. 4 illustrates a heating element and an adhesive frame which comprise the constituent parts of the heater.

FIG. 5 illustrates a thin conductive foil placed around the perimeter of the heater.

FIG. 6 illustrates a perspective view of a digital temperature control unit.

FIG. 7 illustrates a block diagram of the digital temperature control unit.

FIG. 8 illustrates a perspective view of an alternative embodiment of a temperature control unit.

FIG. 9 illustrates a flow chart of a method for installing an embedded heater in a stone countertop.

FIG. 10 illustrates a thin, flexible stick-on heater as applied on the bottom surface of a stone countertop.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general terms, the present disclosure relates to the use of flexible, thin heating elements that are designed to address the thermal properties of stone and are embedded within, or affixed underneath, stone surfaces to warm the stone to a stable, elevated temperature. In particular, the present disclosure provides a flexible heating element, and a method for embedding the heating element into a stone countertop to provide a completely encased heater within a unified countertop slab having no visible protrusions on the bottom surface of the countertop. The present disclosure further provides a stick-on heating pad that is securely affixed and integrated into the underside of the stone countertop. Although the term “stone” is used throughout this disclosure, it is understood that this broad term is used to encompass granite, marble, quartz, cement, stainless steel, glass, copper, concrete, and other materials that are characteristically cool to the touch and which exhibit poor thermal conductivity or exhibit thermal properties that result in thermal variation

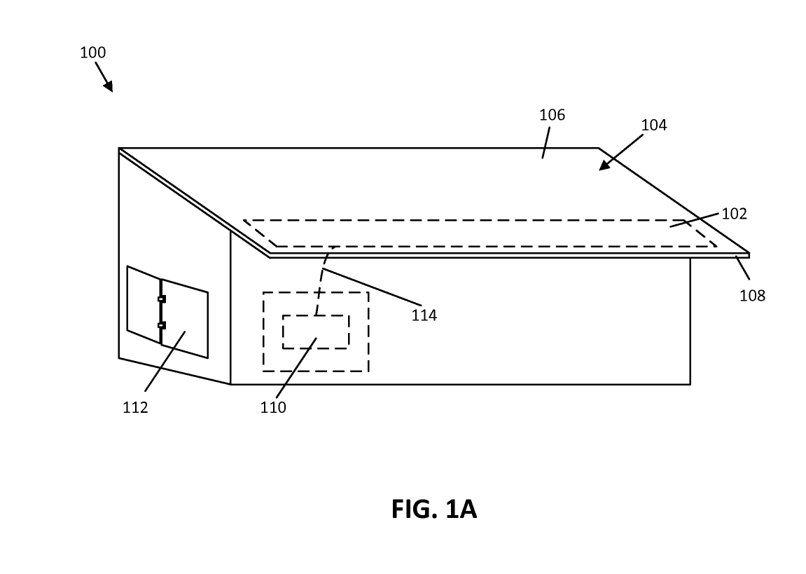

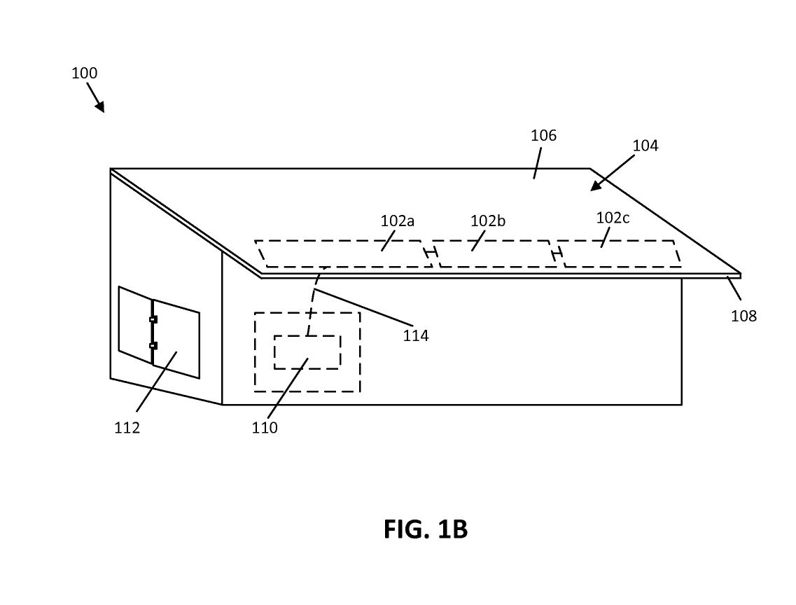

FIG. 1A illustrates a perspective view of an example environment 100 in which an embedded heater 102 for a countertop 104, such as a stone countertop, is used. As shown in this embodiment, the heater 102 (indicated by dashed lines) is embedded in a stone kitchen countertop 104 that is about 2-3 cm thick, providing warmth for people who touch or otherwise come into contact with the countertop 104. Alternatively, such a heater 102 can also be embedded in a workstation, bar, table, shower walls, shower seats, bathtub surrounds, bathtubs, vanities, islands, or any other suitable surface that exhibits poor thermal heating properties. As shown, the heater 102 is positioned within an unsupported overhang 106 of the countertop 104. Although the example illustrates a single heater that is positioned in the unsupported overhang 106, another heater 102 or even a heater 102 having a different shape may also be positioned or embedded in such a way as to provide warmth in other areas of the countertop 104. Accordingly, one embodiment of the present disclosure provides a thin, applied or “embedded” heater 102 that is custom designed in shape and size to fit the shape and size of the surface to which it is applied.

As shown, and will be described in further detail herein, the heater 102 of the present disclosure is designed to provide sufficient and uniform heating along the countertop edge 108 even though there is minimal radial heat transfer within the stone itself. Accordingly, a person sitting near the overhang 106 will feel warmth along the edge of the stone.

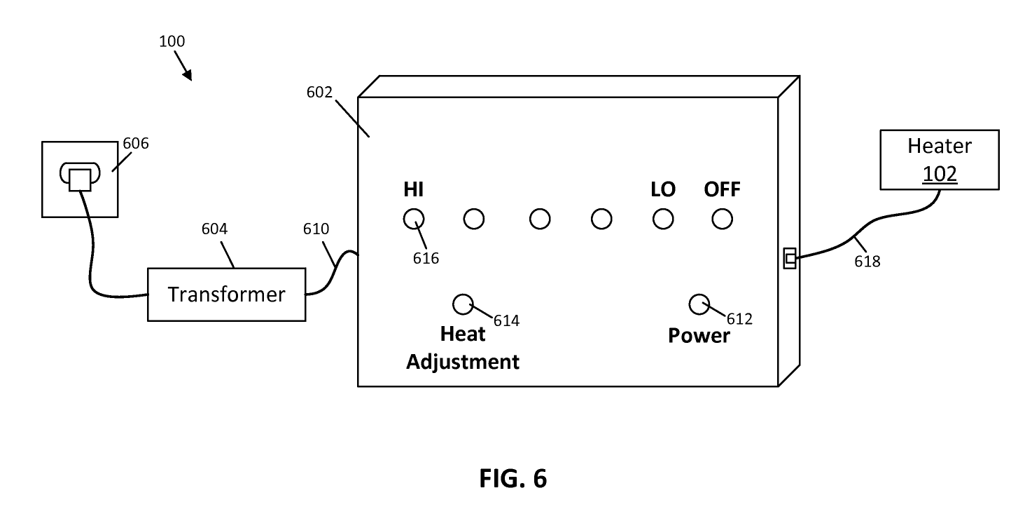

Also shown in this embodiment is a temperature control unit 110 (indicated by dashed lines) that is positioned within a cabinet 112 located underneath the countertop 104. In embodiments, the temperature control unit 110 is used to control the temperature of the countertop 104 by regulating the heater 102. As shown, the temperature control unit 110 is connected to the heater 102 via a wire 114, such as a two conductor cable. In some embodiments, this temperature control unit 110 is a simple on/off switch and in other embodiments, it is a temperature adjustment device used to control the temperature of the countertop. Yet in other embodiments, the temperature control unit 110 is a digital controller including a microprocessor that regulates temperature of the heater 102. Additionally, in some embodiments, a programmable timer may be used to control the duration that the heater 102 is on and/or program certain days and times the heater is on. The temperature control unit 110 is described in further detail with reference to FIGS. 6-8.

FIG. 1B illustrates a perspective view of an example environment 200 in which multiple connected embedded stone heaters 102a-102c for a countertop 104 is used. As shown in the example embodiment, the heater arrangement can be custom designed to fit any countertop shape, or topography. Accordingly, the present embodiment illustrates three heaters 102a-102c connected together in series to create one continuous heater. Additionally shown in this embodiment, only one heater 102a is connected to the temperature control unit 110 via the wire 114. Accordingly, only one temperature control unit 110 is used to control the temperature of each heater 102a-102c.

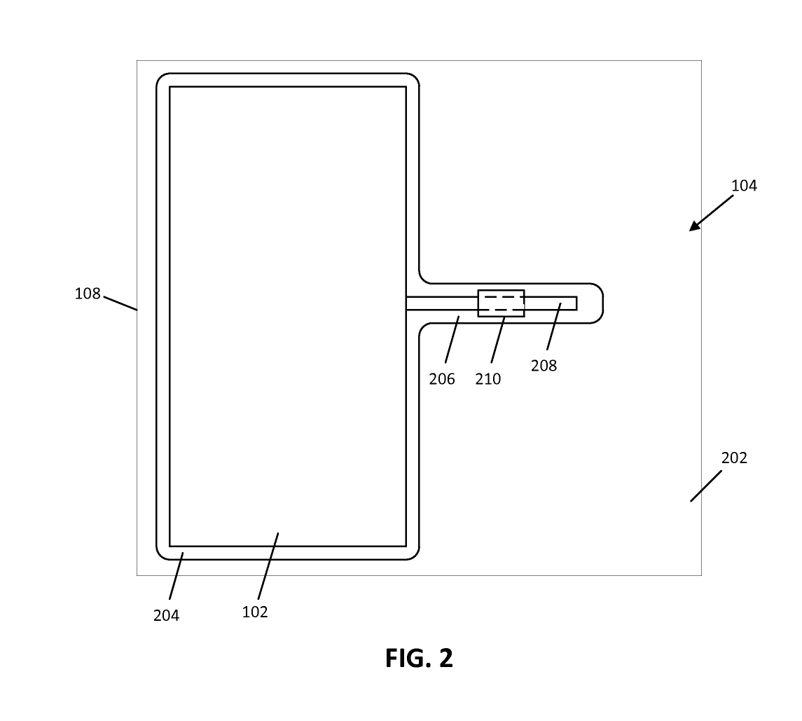

FIG. 2 illustrates a block diagram of the bottom surface 202 of a countertop 104 with an embedded heater 102. As shown, the heater 102 is positioned within a cavity 204 milled into the bottom surface 202 of the countertop 104. In the example shown, the cavity 204 is slightly larger than the size of the heater 102 and also includes a channel 206 for routing electrical connection wires. Because the heater 102 is only about 0.01″−0.02″ thick, the milled cavity 204 is approximately ⅛″ deep. However, depending on the thickness of the countertop 104 other depths may alternatively be used. Accordingly, a thin heater 102 is associated with a shallower cavity 204, which reduces the cost and milling time of installing the embedded heater. In some embodiments, a 0.125″ deep cavity will accommodate a 0.01″ thicker flexible heater.

In the example shown, the distance between the edge 108 and the cavity 204 is approximately ½″; however in alternative arrangements, other distances can also be used for a particular countertop 104 or other stone surfaces. For example, for highly decorative edges, the distance between the cavity 204 and the edge 108 may be ¾″ in order to maintain an integral wall, to avoid having a wall too thin to cause damage to the stone.

As will be discussed in further detail below, in some embodiments the heater 102 includes an adhesive on its upper surface that is used to securely affix the heater 102 inside the milled cavity 204. After installation of the heater 102, a colored, liquid epoxy is poured into the cavity 204, over the heater 102, and bonded to the stone to completely encase the heater within the counter 104. In such embodiments, the epoxy is loaded with color particulates so that the finished surface color closely resembles, or compliments the countertop color. This provides an important cosmetic feature in that countertops with overhangs and/or exposed lower surfaces will have a professional and visually appealing surface, even though it is on the bottom surface of the countertop 104. Installation of the embedded heater 102 and the epoxy according to such embodiments is described in further detail below.

As shown, the milled channel 206 is used to route electrical wires 208 to an electrical outlet that provides power to the heater 102. The channel 206 is designed to route the electrical wires 208 from the heater 102 to an area in a cabinet or table on which the countertop 104 is positioned, and where the wires can exit and not be visible and/or be in an area where they cannot be damaged or inadvertently pulled. The length of the channel 206 depends on the distance between the heater 102 and an opening to the cabinet. In example embodiments of the present disclosure, a strain relief 210, such as a rubber boot, is placed around the electrical wires 208 at the opening where the wires 208 exit the channel 206. The strain relief 210 prevents the electrical wires 208 from being inadvertently damaged. A portion of the strain relief 210 is embedded in the channel 206 while a portion is not embedded thereby protecting sharp bending of the wires at the transition point. In various embodiments, the strain relief 210 can be movable along the wire 208 to adjust a point at which strain would be experienced by the wire 208 (e.g., at the point where the wire 208 would depart from or extend away from the countertop surface). In some embodiments, the strain relief 210 is a rubber sleeve, although in other embodiments, other materials may also be used.

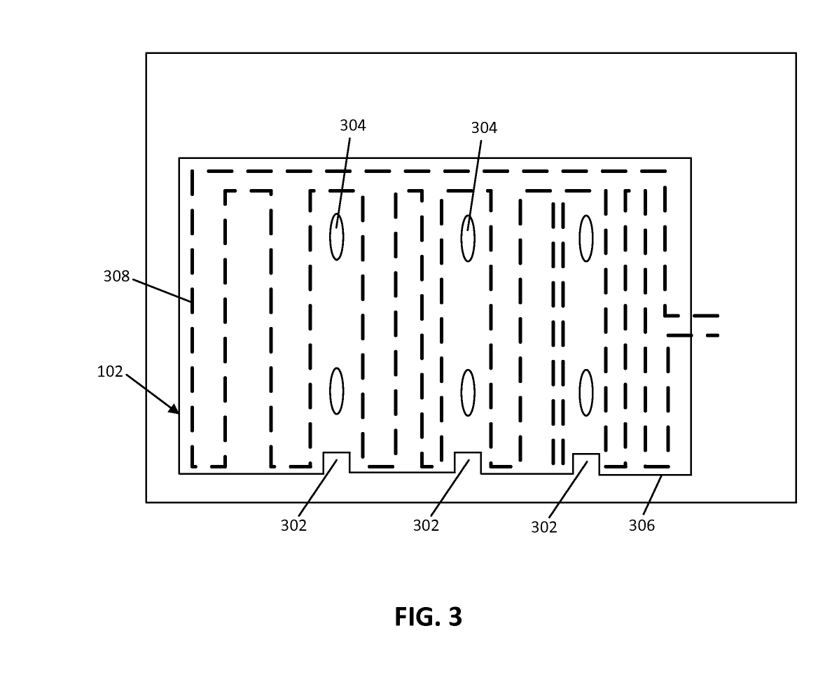

FIG. 3 illustrates an embodiment of a thin, flexible heater 102 that provides heat to the edge 108 of a countertop 104. The heater 102 of the present disclosure relates to a flexible heater manufactured out of thin plastic film such as polyester and polyimide. Such flexible heaters can be obtained from various flexible heater manufacturers such as All Flex, Inc. of Northfield, Minn. and Minco Products, Inc. of Fridley, Minn. These thin, flexible heaters 102 as used in the present disclosure are produced using thin foils 308 as the heating element. Examples of foil include 0.0014″ thick copper foil, 0.001″ Inconel foil, 0.00625″ thick cupronickel foil, among others. The thin foil 308 enables the heater 102 to be wide and flat. This allows the heating element pattern to be very close together, thereby providing even heat to the stone countertop 104. The heating element pattern can be of any design, but for example, may be 0.1″ wide and spaced 0.15″ apart, providing substantially uniform heat throughout the countertop 104 (e.g., heating to a common, raised temperature within an approximately 0-10 degree Fahrenheit range across the area to which the heater is applied).

Although the heaters 102 described in the present disclosure are foil based, there are other thin heater technologies that can also be utilized in conjunction with a countertop 104. An example of one such heater includes polymer resistive inks on plastic film. Resistive inks are printed on plastic films to provide the desired patterns or shapes intended to be applied to the bottom surface 202 of the countertop 104 in a desired shape or configuration. In still further examples, a carbon-impregnated polymer material could be used, in which an extruded material can be shaped in a manner to provide a pattern analogous to a printed ink pattern.

Additionally, a pattern of the heating element need not be consistent across all areas of a particular surface. For example, in various embodiments, the shape, configuration, and spacing of heating elements could be provided to allow heating in desired areas of the countertop 104. Accordingly, although a heater 102 covers an entire surface area of the countertop 104, the heating element can be shaped to introduce heating in various parts of the countertop 104 while leaving other areas unheated. Additionally, within one heater, individual heating elements can be widened and/or narrowed to adjust to specific heat loss/heat gain characteristics of the countertop. Accordingly, by varying the width of the heating element, the heat distribution can be adjusted to focus on certain parts of the countertop 104, such as the edge 108

Additionally, in some embodiments, heater systems useable in the present disclosure provide an open-loop control system in which the wattage output of the heater 102 is controlled by the input voltage, thereby eliminating the need for a control system based upon sensing the countertop temperature to cycle the voltage on and off. The wattage output of the heater is designed to have a watt density of approximately 0.15 watts per square inch. Although this low wattage level results in slow heating of the countertop 104, for most applications, accelerated heating of a countertop 104 is not highly desired, and can introduce risk of fracturing the stone that may be caused by thermal gradients that are otherwise present in existing radiant heating systems. The wattage level can be determined solely with a consistent input voltage that produces the desired temperature of the stone countertop 104. In some embodiments, the resistance of the heating element is specifically designed to align with the voltage of the transformer to produce the desired wattage, for example, 20-25 watts per square foot. Over time, the thermal output of the heater 102 will migrate into the countertop 104 and the countertop will eventually stabilize between heat loss and heat gain. Accordingly, the power to the heater 102 will not cycle on and off based upon a temperature reading like in a closed loop system. Rather, the voltage will remain consistent and will not exceed the wattage ability of the heater 102 itself, ensuring the countertop 104 will not overheat. Because the heater 102 is self-regulating, a sensing control device that is used to detect when the countertop 104 has reached a desired temperature is not required.

The heater 102 of the present disclosure is designed to provide sufficient wattage to heat the countertop 104 to comfortable levels, but also operates on low voltage so that safety concerns are minimized. The low watt density of the heater 102, when powered with 12 volts, for example, elevates the temperature approximately 25 degrees above the original surface temperature of the countertop 104 in approximately 70-90 minutes. This is assuming there is little or no airflow over the countertop 104 and assuming there are no atypical thermal loss attributes or insulative attributes impacting the countertop 104. Although an input of 12 volts is described, other voltage levels can alternatively be applied to provide the desired wattage output of the heater 102. Additionally, for each square foot of heater 102, the consumed current at 120 volts may be as low as 0.196 amps. Because typical heater sizes are below 10 square feet, the current draw will be well under a normal 120 volt circuit limit of 15 or 20 amps. Accordingly, the heating system's low voltage allows a typical user to leave the heater turned on for long time periods or even permanently due to its low power consumption. The chart below identifies approximate electrical characteristics associated with the heater 102 of the present disclosure.

| Heater Size (Sq. Ft.) | Current Draw on 110 V Line |
|---|---|
| 3 | 0.59 A |
| 4 | 0.79 A |
| 5 | 0.89 A |
| 6 | 1.18 A |
| 7 | 1.37 A |
| 8 | 1.57 A |
| 9 | 1.77 A |
| 10 | 1.96 A |
| 11 | 2.16 A |
| 12 | 2.36 A |
| Each Additional Sq. Ft. | 0.196 A |

In some embodiments, the heater 102 is precisely designed to a specific resistance for the countertop 104 in which it is installed and that resistance is matched to a fixed low voltage input power and current level so that the heater 102 delivers a predetermined wattage that produces a targeted thermal elevation in the countertop 104.

The heater 102 can be custom designed in shape and size to fit the countertop's 104 shape and size. Additionally, the thin foil 308 can also be designed with a unique pattern to ensure uniform thermal distribution. The thin foil 308 can be custom designed with an element width, foil thickness options, resistive properties of the foil, and overall length so that the resulting wattage is consistent for the applied voltage needed for the stone to warm approximately 20 degrees or to a desired temperature rise. The present disclosure includes custom designing the elements when there are multiple and separate heaters, but when joined, they are collectively a part of the overall countertop 104 layout and the resulting wattage output is consistent for all heaters. Accordingly, each separate heater 102 can be joined in series or parallel so that one power input can be used while providing the same thermal output as if only one heater of smaller size is used.

As discussed above, countertops 104 have minimal lateral heat spreading and therefore generally require the heating element to be located directly under the area to be heated. As such, in order to heat the edge 108 of the countertop 104, the heating element must be positioned near the edge 108. However, because the epoxy that is poured over the heater 102 bonds directly to the stone itself, abutting the heater close to the edge 108 is undesirable because it reduces the available surface area to where the epoxy may bond. Accordingly, notches 302 in the front edge 306 and cut-outs 304 in the heater 102 are provided to increase the surface bonding area of the epoxy in order to hold the heater 102 securely while also allowing edge 306 heating. Accordingly, the heater 102 can be positioned as close to the edge 108 as possible so that heat radiates thereto. Although this example embodiment illustrates a heater 102 having both notches 302 and cut-outs 304, it is understood that either solution can individually be employed to allow the epoxy to bond to the countertop 104, thereby providing enhanced integrity of the epoxy strength within the cavity 204.

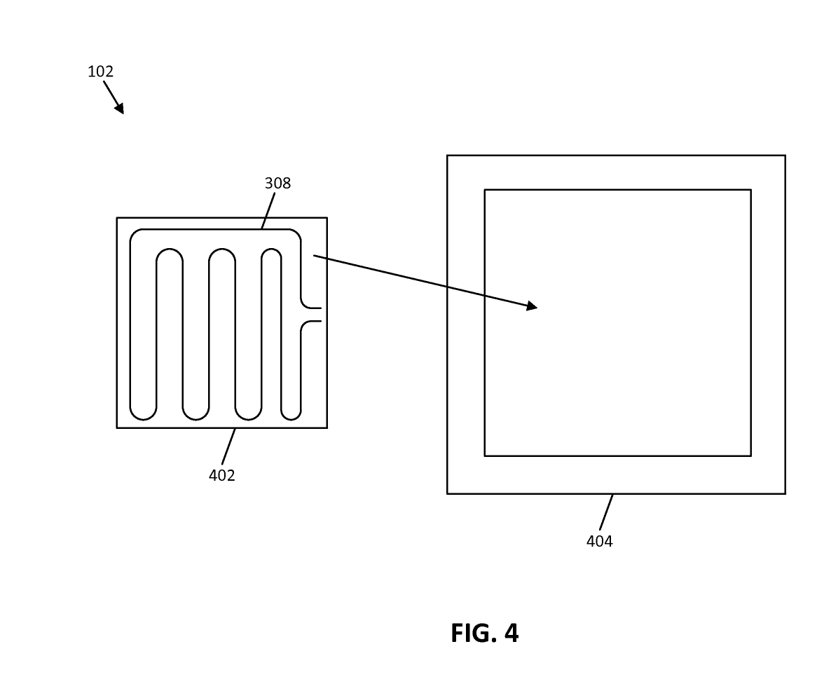

FIG. 4 illustrates a stick-on heating element 402 and an adhesive frame 404 that comprise the constituent parts of the heater 102, according to some embodiments. As shown in the example embodiment depicted in FIG. 4 and as discussed above, the heater 102 has a perimeter adhesive frame 404 made of pressure-sensitive adhesive material that bonds to the countertop 104 surface and to a polycarbonate protective layer. This perimeter adhesive provides a liquid and mechanical seal affixing the overall heating element 402 to the countertop.

Laminated within the perimeter adhesive frame 404 is the heating element 402. As shown, the heating element contains the thin foil 308 that is patterned, for example, a 0.1″ wide and 0.15″ spaced pattern, providing a substantially uniform heat throughout the countertop 104. To enable the stick-on option, there is additionally adhesive applied to the body of the heater.

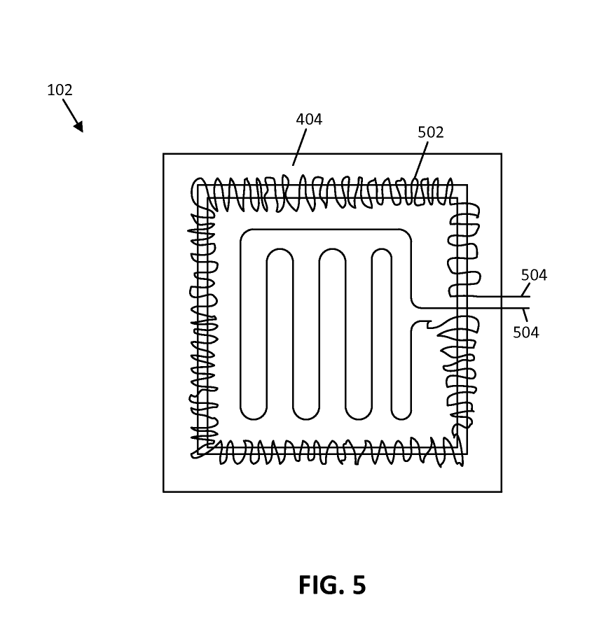

FIG. 5 illustrates a thin conductive foil strip 502 that is placed around the perimeter of the heating element 402, in some embodiments. In such embodiments, the thin conductive foil strip 502 can be a copper foil that is approximately 0.0014″ thick and 0.05″ wide; however, in alternative embodiments, other sizes or materials of foil strips could be used as well. As shown, the thin conductive foil strip 502 is placed within the layers of the heating element 402 in a bridging pattern around the perimeter of the heating element 402 and bonded partially to the perimeter of the adhesive frame 404. The two end points 504 of the thin conductive foil strip 502 are laid in series with the heating element 402. Although not shown, a polycarbonate layer covers the entire heater 102. As an added safety feature, if the heater 102 detaches from the surface, the perimeter adhesive frame 404 will peel off first, separating from the heating element 402. Accordingly, the foil strip 502 will tear, creating an open circuit and disabling the heater 102.

In the depicted embodiment, the heater 102 integrates several safety features. The disclosed heater 102 operates on low DC voltages, typically about 12 volts (although in installations of larger size, the heater 102 may operate on about 24 volts). Additionally, provided transformers act as a voltage regulator and disconnect the voltage from the heater element if the voltage exceeds a predetermined level. In some embodiments, the transformers may also provide overcurrent protection. In such an embodiment, the transformers are connected to a snap-action fuse component that trips in the event the heater 102 pulls an excessive current draw.

Alternatively, the heater 102 may incorporate a snap-action thermal fuse in series with the heating element 402. Such a thermostat is normally closed, but when the thermostat senses temperatures above a predetermined temperature, such as 167 degrees Fahrenheit, the thermostat opens and disconnects power to the heater 102. Once the thermostat senses the temperature drop to a safe level, it reconnects power to the heater 102.

FIG. 6 illustrates a perspective view of a digital temperature control unit 602. In the example embodiment of the present disclosure, the temperature control unit 602 is an embodiment of the temperature control unit 110 discussed with reference to FIG. 1 and is used to regulate the temperature of the countertop 104 by controlling power to the heater 102. As described herein, the digital temperature control unit 602 is positioned in an area near the countertop 104, such as in a cabinet. As shown in this embodiment, the digital temperature control unit 602 receives low voltage from the output 610 of a transformer 604, which is connected to an AC wall outlet 606, and delivers power through a power line 618 to the heater 102. As shown in this embodiment, the transformer 604 converts high AC voltage from the wall outlet 606 to low direct current (DC) voltage, which is delivered to the temperature control unit 602. In some embodiments, in addition to providing low voltage to the temperature control unit 602, the transformer 604 also provides protection to the system in the form of a snap action fuse housed within the transformer 604. The snap action fuse can be used to disconnect power supplied to the temperature control unit 602 in the event temperature exceeds a predetermined level.

In this embodiment, the temperature control unit 602 enables temperature adjustment for the countertop 104 by adjusting a duty cycle of power application to the heater 102 in predetermined time increments. In particular, to maintain a constant temperature of the countertop 104, in some embodiments, the digital temperature control unit 602 will cycle power to the heater 102 in predetermined time increments. For example, to regulate the temperature of the heater 102 to 90 degrees Fahrenheit, the digital temperature control unit 602 will turn the heater 102 on for 30 seconds and off for 10 seconds. Because of the heat transfer properties of the countertop 104, the temperature of the countertop 104 changes slowly in response to temperature changes of the heater 102. Accordingly, fluctuating power on and off to the heater 102 in predetermined time increments will result in maintaining a controllable, constant temperature of the countertop 104.

In alternative embodiments, the temperature control unit 602 can operate according to an alternative arrangement in which an output voltage delivered to the heater 102 is varied, for example linearly or step-wise in response to user-selectable changes in settings. In such embodiments, a greater voltage selection will result in higher heat dissipation. Additionally, in some embodiments, a feedback mechanism (e.g. a temperature sensor or other mechanism) could be used to ensure that overheating of the countertop is avoided.

In the example embodiment of the present disclosure, the digital temperature control unit 602 uses a microprocessor to control power to the heater 102. Also shown in this embodiment, the digital temperature control unit 602 includes a power indicator 612 and a heat adjustment button 614 that is used to adjust the temperature of the countertop 104. In this example, the digital temperature control unit 602 also includes a plurality of light emitting diodes (“LEDs”) 616 to indicate the desired countertop 104 temperature selected using the heat adjustment button 614.

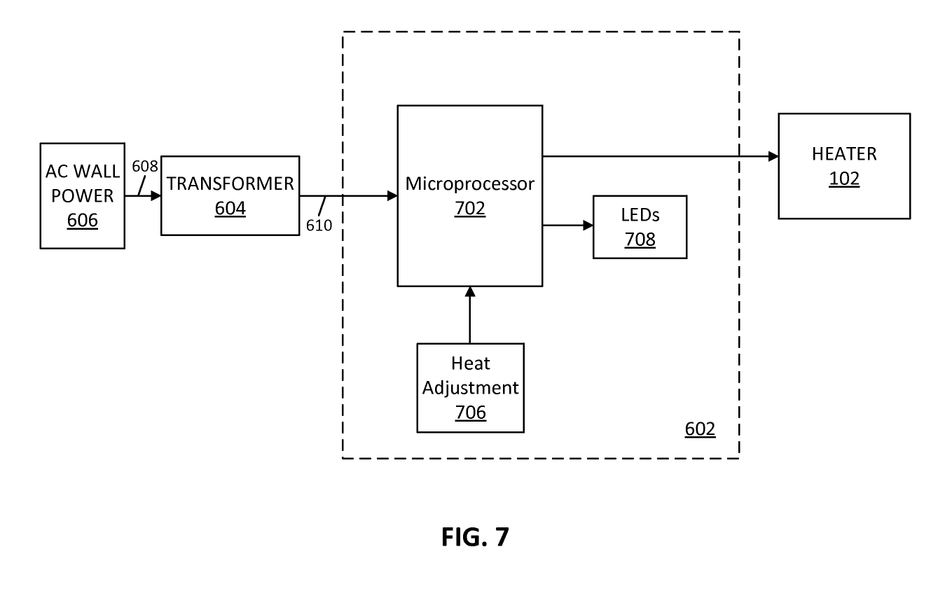

FIG. 7 illustrates a block diagram of the digital temperature control unit 602 (indicated by dashed lines) as shown in FIG. 6. As shown in this embodiment, a transformer 604 is connected to the AC wall power 606 on the transformer input 608 and converts the power to a low, DC power useable by the digital temperature control unit 602, such as, for example, 5 volts or 24 volts. As shown, the power is supplied to the microprocessor 702 positioned inside the digital temperature control unit 602.

As discussed herein, the microprocessor 702 is used to control the temperature of the stone countertop 104 by fluctuating power to the heater 102. As discussed with reference to FIG. 6, a user may adjust the temperature of the countertop 104 using the externally positioned heat adjustment button 614, which is electrically connected to the microprocessor 702, positioned inside the digital temperature control unit 602. As discussed with reference to FIG. 6, the microprocessor 702 controls the temperature of the countertop 104 by fluctuating power to the heater 102. In particular, the microprocessor 702 will adjust the duration of the power on/off cycle according to a predetermined amount that is associated with a selected temperature. For example, if a user wishes to reduce the temperature of the countertop 104, the microprocessor 702 will decrease the duration of the power on cycle, thereby decreasing the amount of power delivered to the heater 102, resulting in a reduced temperature of the countertop 104. Alternatively, if a user wishes to increase the temperature of the countertop 104, the microprocessor 702 will increase the duration of the power on cycle, thereby increasing the amount of power delivered to the heater 102, resulting in an increased temperature. In some embodiments, after power loss and upon subsequent power gain, the microprocessor 702 will continue to deliver power according to the previously set power setting. Accordingly, the power setting may be stored in a nonvolatile memory component that retains data in memory, despite losses in power.

In response to user inputs, such as, for example, heat adjustment using the heat adjustment button 614, the microprocessor 702, using the LED circuit 708, lights the externally positioned LEDs 616 accordingly.

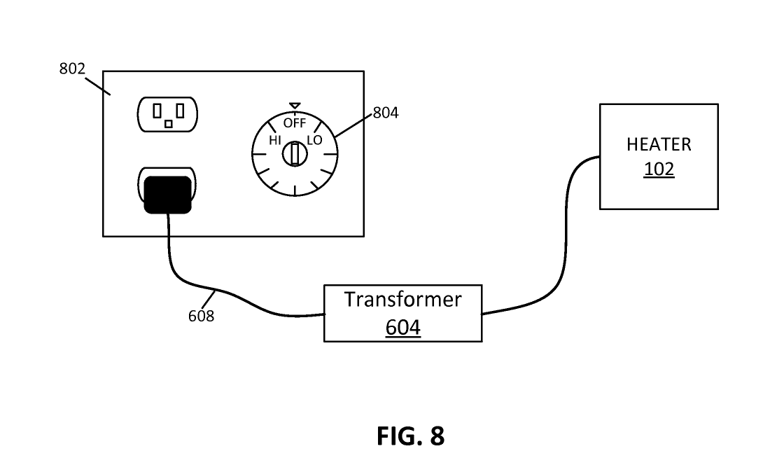

FIG. 8 illustrates a perspective view of an alternative embodiment of a temperature control unit 802. In this example embodiment, the temperature control unit 802 includes a timer switch, such as a adjustment knob 804 that is used to adjust the time increments to which power is applied to the heater element associated with the countertop 104. In particular, the temperature control unit 802 regulates the fluctuation of the power on/off cycle delivered to the input 608 of the transformer 604 in response to a temperature selected using the temperature adjustment knob 804. The output 610 of the transformer 604 delivers low voltage power to the heater 102 through the power line 618. Accordingly, the temperature of the countertop 104 is adjusted similar to the discussion herein with reference to FIG. 7.

As described above, electrical wires 208 are routed from the heater 102 to an area in the cabinet or table where the electrical wires 208 are not visible and in an area where they cannot be damaged or inadvertently pulled. These electrical wires 208 connect to the transformer power line 618 or connect directly to the transformer 604.

Although a temperature adjustment knob 804 is illustrated in this embodiment, it is understood to be an example embodiment and other switches may alternatively be used. Additionally, a programmable timer that maintains control of the heater 102 may also be used in the system. In such an embodiment, the electronic controls for the heater 102 enable a programmable timer to control operation of the heater 102 at predetermined times.

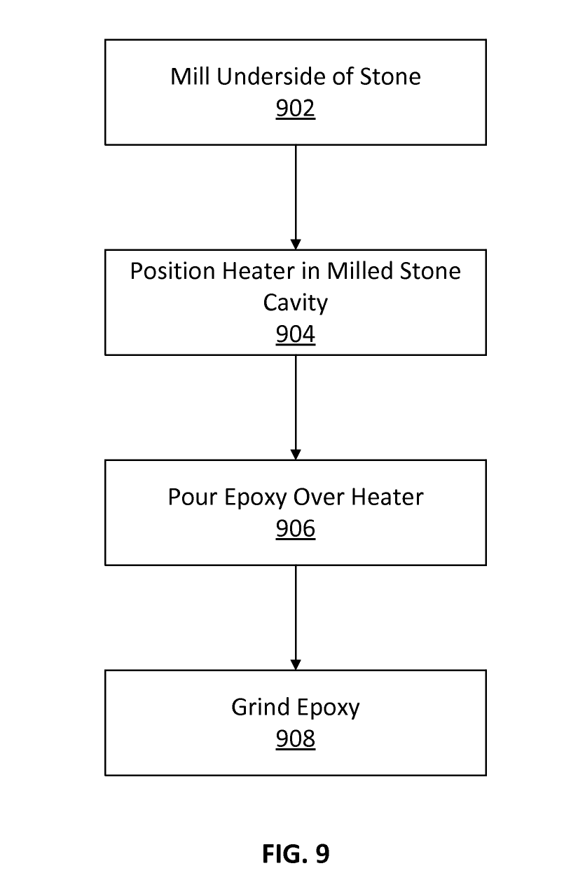

FIG. 9 illustrates a flow chart of a method 900 for installing an embedded heater 102 in a stone countertop 104. This flow chart begins with operation 902, which provides for milling a cavity 204 and channel 206 in the bottom surface 202 of a stone countertop 104, as described with reference to FIG. 2. As an initial matter, milling the stone may be performed in several steps using a fabricator tool. It is recommended that the channel 206 is cut first followed by milling of the heater cavity 204. In some embodiments CAD tools are used to identify the details needed for milling the heater cavity 204.

The channel 206 is milled to allow electrical connection wires to be routed there through. The length of the channel 206 depends where the electrical wire 208 can drop down into the cabinet upon which the counter 104 is positioned. In some embodiments the channel 206 is approximately ¾″−1″ wide with a depth of approximately ½″.

To begin, the stone may be blade cut to initiate a channel width and depth of desired parameters using a standard rotary cutting blade (¼″ thick and 5″ in diameter or similar). After a series of cuts are made, a side-cutting end mill may be used for the remainder of the channel, without the need of a plunging tool. The side-cutting end mill is used to cut the channel 206 according to predetermined measurements using recommended tool speeds provided by the tool manufacturer. In some embodiments, this tool speed is approximately 5000-7000 RPM with a speed of approximately 10″ linear per minute. It is acceptable to over-mill the end of the channel, thereby having a wider or longer channel than specified.

Next, the cavity 204 is milled. In some embodiments, the cavity 204 is milled approximately ⅛″ larger per side than the heater 102 and approximately ⅛″ deep. The cavity 204 may be milled anywhere in the stone countertop 104 itself, however, for edge heating, it is preferable that the cavity 204 is milled about ½″ from the edge for traditional edges and expanded to approximately ¾″ for decorative edges, as described with reference to FIG. 2.

In some embodiments, a ½″ bit is used to mill the perimeter of the cavity 204. The ½″ bit is preferable for the perimeter cut because of the corner radius requirements of the cavity. In some embodiments, the tool speed used to cut the perimeter is about 5000-7000 RPM with a speed of 20″ linear per minute.

Following the perimeter cut, a 3.5″ diameter bit is used to complete the cavity 204. In embodiments, cutting the cavity 204 is performed using a normal surface cut process that sweeps back and forth, milling ⅛″ of stone. In some embodiments, the tool speed is approximately 5000 RPM with a speed of 30″ linear per minute.

In operation 904, the heater 102 is positioned in the milled stone cavity 204. As an initial matter, a dry-fit is performed, wherein the heater 102 is first temporarily placed inside the cavity 204 to determine whether it fits as desired. Next, using a marker, slot openings corresponding to the notches 302 and cut-outs 304 of the heater 102 are traced onto the cavity 204 surface. Then, the heater 102 is removed, and using a hand pneumatic grinder, each marked area is grinded to provide the epoxy with further depth and stone surface area to which it may attach.

The heater 102 is then prepared for mounting in the cavity 204. First, the paper liner is peeled from the back of the heater 102, exposing the adhesive. The back of the heater 102 is then mounted in, and pressed firmly against the cavity 204.

Duct tape is positioned in the channel 206 approximately 4-6″ from the heater, in order to construct a dam to prevent the epoxy from flowing far into the channel, allowing the electrical wires 208 to be routed through the channel 206. This dam location typically correlates to the location at which the cable will be pulled into the cabinet. A strain relief 210 such as a rubber boot that encases the wires is then positioned within the channel to straddle both sides of the duct tape. As described above with reference to FIG. 2, the rubber boot provides protection for the electrical wires 208 as they exit the hardened epoxy. Half of the boot is intended to be submerged in the epoxy while the other half of the boot is loose. Accordingly, a portion of the rubber boot will be covered with epoxy, and the other portion will be free of epoxy, allowing it to bend freely within the channel 206. The portion of the electrical wires 208 and the rubber boot that is positioned between the heater 102 and the duct tape is depressed into the channel 206 for full submersion in the epoxy.

In operation 906, epoxy is prepared and poured over the heater. In the present disclosure, the selected epoxy or sealant is stable and does not experience thermal expansion or contraction with temperature variances. Approximately 18 fluid ounces of epoxy is used for every square foot of cavity area that is ⅛″ deep. Two generally available epoxy mixing compounds comprising a polyester resin (generally referred to as Part A and Part B), or any type of sealing polymer, are then poured into separate containers, wherein twice as much of Part A compound is used as compared to Part B compound. After color matching is performed, color pigmentation is thoroughly mixed into the Part A compound. Once the desired color is achieved, Part A and Part B are mixed together and thereafter poured onto the heater 102, electrical wires 208, and strain relief 210 that are positioned in the cavity 204, carefully ensuring the epoxy fills the slots to ensure bonding to the stone. The epoxy is poured until it fills the cavity 204 entirely, without flowing over and onto the surface of the stone, but such that the surface of the epoxy layer is slightly higher than the stone. No further action is taken until the epoxy is fully hardened in about 20-24 hours.

In operation 908, the surface of the epoxy is ground so that the hardened epoxy is flush and smooth with the surface of the bottom side 202 of the stone. Finally, the duct tape is removed and the loose electrical wire 208 is secured within the channel 206. Accordingly, the stone countertop 104 is now ready to be installed.

Note that in embodiments including multiple heaters 102 joined in series, as described with reference to FIG. 2, each operation may be performed multiple times, corresponding to the number of heaters 102 installed. In particular, operations 902-906 may be repeated for each heater 102 installed.

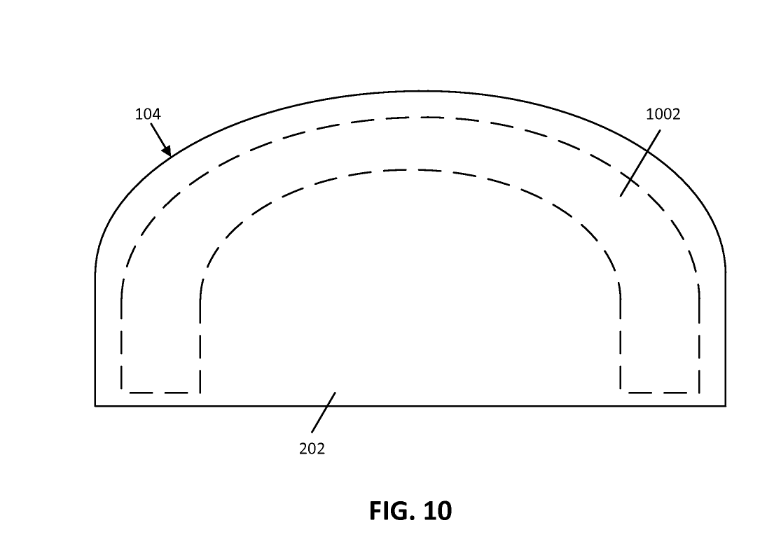

FIG. 10 illustrates a thin, flexible stick-on heater 1002 as applied on the bottom surface 202 of a countertop 104, such as a stone surface, according to a further example embodiment. For already installed countertops or surfaces, the stick-on heater 1002 provides an alternative solution to the embedded heater 102. The stick-on heater 1002 is constructed using the same heater 102 as described in the present disclosure, however, rather than being embedded within the countertop 104, it is affixed to the bottom side 202 of the countertop 104. The stick-on heater 1002 can also be custom sized to a particular countertop 104. Accordingly, the provided electrical input cable may be positioned close to an available electrical outlet.

For safety purposes the stick-on heater 1002 adheres to the bottom 202 of the stone countertop 104 without delamination over time. The stick-on heater 1002 is constructed with high bond adhesives to permanently adhere the stick-on heater 1002 to the bottom side 202 of the stone countertop 104. Various adhesives may serve this purpose, including for example, 3M Corporation's VHB pressure sensitive tape.

The stick-on heater 1002 as provided in the present disclosure is designed to withstand impact, abrasion, and puncture from chair arms, legs, and other mechanical elements. Additionally, the exposed outer surface of the stick-on heater 1002 is constructed with high impact resistant polycarbonate. Despite its ability to withstand such forces, the stick-on heater 1002 maintains a thin profile so as not to protrude down and interfere with objects underneath the countertop 104. In some embodiments, the polycarbonate is provided in a sleek, matte finish and may additionally be available in a multitude of colors to visually match with the surface of the stone. An example brand of polycarbonate is Lexan, which is produced by General Electric Company. This example brand provides excellent mechanical protection and is additionally flame retardant, while not interfering with the high bond strength of the internal adhesives of the heater.

As an added safety feature, the stick-on heater 1002 is designed with peel-protection where the conductive element is broken if the perimeter bond layer is peeled away.

In order to attach the stick-on heater 1002 to a countertop 104, the bottom surface 202 of the stone must be pre-cleaned with a solution made of a 50% mixture of isopropyl alcohol and a 50% mixture of water. The solution is used to remove grease, oil, particulates, dirt, grime, and dust. In some embodiments, the bottom surface 202 may be modified to enhance adhesion of the stick-on heater 1002. Examples of surfaces that may require modification are rough cut granite where the stone's surface has not been modified from the original cutting tool from the quarry, wood surfaces where wood or plywood has been adhered to the bottom side 202 of the stone, and stone surfaces that are irregular or non-smooth. Modification of the surface includes coating the stone with a specially formulated epoxy or liquid coating that is engineered for high adhesion to stone wood, or other porous surfaces. In some embodiments, such a coating hardens and is then highly receptive to adhesion with pressure sensitive adhesive. Example surface preparation material is available from Bonstone Materials Corporation of Mukwango, Wis.

The stick-on heater 1002 is affixed to the cleaned area. In some embodiments, a template may be used to guide in mounting the stick-on heater 1002 as desired. A high pressure roller may also be used after the heater has been initially attached, applying pressure of 15 psi or greater over the sticker to ensure it is securely affixed to the countertop 104. The bonding adhesives within and external to the stick-on heater 1002 are liquid and chemical resistant. Accordingly, the stick-on heater 1002 is sealed against liquids that may be spilled on the stop surface of the countertop 104 and leaked down and around the countertop edge 108.

The provided electrical input cable is plugged into an available electrical outlet, or otherwise connected to a power source. In some embodiments, a temperature control system as described above with reference to the embedded heater is also installed, allowing for the same temperature controls as is provided with the embedded heater.

As described herein, the present disclosure provides a new system and method for warming countertops to a stable, elevated temperature through the use of an embedded heater or an ultra-thin stick on heater that is uniquely designed to address the heat transfer thermal properties of stone, including edge heat. The heaters described in the present disclosure further provide sufficient wattage to heat the counter to comfortable levels but also use low voltages, thereby minimizing safety concerns associated with the heater. The embodiments further disclose heating elements with a very low current draw. The open loop system as disclosed herein is yet another advantage described herein. In this open loop system, the wattage output of the heater is controlled by the power on off fluctuations regulated by the temperature control unit.

As described herein, features of the embedded heater include a covered epoxy that blends in with the color of the stone Additionally, the embedded stone heater 102 is designed to a specific resistance for a given countertop area that corresponds to a fixed low voltage input power and current level, thus allowing the heater to deliver a predetermined wattage that produces a targeted thermal elevation in the stone countertop 104. Additionally, the heater disclosed herein can be joined with other individual heaters 102 in series or parallel, using a single power input while providing the same thermal output as if only one heater of smaller size is used.

Additionally, the stick-on heater embodiment is manufactured using a flame retardant material that is offered in a variety of colors, matching various colors of stone. Additionally, the stick-on heater as described in the present disclosure provides a method for application on rough, non-uniform surface areas. The stick-on heater is also custom sizable to any countertop shape and/or size in order to match the shape of the existing countertop. The stick-on heater is also configured to be applied around core holes in the countertop or features such as support brackets. The stick-on heater also includes a safety feature wherein if the heater peels from the surface or otherwise becomes delaminated from the stone surface, the perimeter adhesive frame will peel first, separating from the heater body and disabling the heater.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A system for heating a countertop, the system comprising:
a. a heater comprising a plastic film having a patterned heating element disposed thereon, the patterned heating element defining a resistive path on the plastic film shaped to provide closely-spaced heating traces and shaped to be affixed to an underside of the countertop; and
b. a control unit electrically connectable to the heating element via a wire, the control unit configured to deliver a direct current signal having a predetermined voltage level to the heating element according to a user selectable power level.

2. The system of claim 1, wherein the user-selectable power level defines a duty cycle for delivering the direct current signal to the heating element at the predetermined voltage.

3. The system of claim 2, wherein the predetermined voltage is between about 5 and about 24 volts.

4. The system of claim 1, wherein the heating traces are spaced between about 0.05 inches and 0.5 inches apart.

5. The system of claim 1, wherein the control unit includes a transformer configured to receive an alternating current signal from a wall outlet and output a direct current signal.

6. The system of claim 5, wherein the control unit further comprises:
a. a microcontroller configured control delivery of the direct current signal to the heating element; and
b. a nonvolatile memory configured to store at least one user-selectable power level associated with each of a plurality of user selectable power levels.

7. The system of claim 5, wherein the control unit includes a dial allowing for user adjustment of the duty cycle, wherein the dial is electrically connectable between an alternating current power source and the transformer.

8. The system of claim 1, wherein the heater has a thickness of less than about 0.03 inches.

9. The system of claim 1, wherein the heater includes an adhesive applied to at least a portion of a surface of the plastic film.

10. The system of claim 1, further comprising a compound useable to encapsulate the heater within a cavity formed in the underside of the countertop.

11. A heating system for a countertop, the heating system comprising:
a. a heater comprising a plastic film having a patterned heating element disposed thereon, the patterned heating element defining a resistive path on the plastic film shaped to provide closely-spaced heating traces, the heater installed on an underside of a countertop;
b. a control unit electrically connected to the heating element, the control unit configured to deliver a direct current signal having a predetermined voltage level to the heating element according to a user selectable power level, the user-selectable power level defining a duty cycle for delivering the direct current signal to the heating element at the predetermined voltage; and
c. a wire extending from the heater to the control unit.

12. The heating system of claim 11, wherein at least a portion of the wire extends through a channel formed in the underside of the countertop.

13. The heating system of claim 12, further comprising a strain relief positioned along the wire to maintain a bend radius of the wire as the wire extends from the heater.

14. The heating system of claim 11, wherein the countertop comprises a material selected from among a group of materials comprising stone, granite, marble, quartz, cement, concrete, stainless steel, glass, and copper.

15. The heating system of claim 14, wherein the underside comprises a second material different from the material.

16. The heating system of claim 11, wherein the resistive path varies in resistance, thereby varying an amount of heat delivered to areas of the countertop.

17. The heating system of claim 16, wherein the patterned heating element includes an edge portion and a center portion, and wherein a portion of the resistive path along the edge portion has a higher resistance than a second portion of the resistive path located in the center portion to provide more heat along the edge portion than is delivered to the center portion.

18. The heating system of claim 11, further comprising an adhesive affixing the heater to the underside of the countertop.

19. The heating system of claim 11, wherein the patterned heating element is shaped and sized to be affixed to an underside of an overhanging portion of the countertop.

20. The heating system of claim 11, wherein the resistive element is formed from a material comprising at least one of a metal-based foil, a resistive ink, or a carbon loaded polymer.
